(19) United States
(12) Patent Application Publication
(10) Pub. No.: US 2004/0232242 A1
(43) Pub. Date: Nov. 25, 2004

(54) Language insensitive marking system using photo luminescent printing of bar coded emergency information

(76) Inventor: Charles Bolta, Ft. Collins, CO (US)

Correspondence Address: Emery L. Tracy, P.O. Box 1518, Boulder, CO, 80306-1518, US

(21) Appl. No.: 10/826,121

(22) Filed: Apr. 16, 2004

Related U.S. Application Data
(60) Provisional application No. 60/464,080, filed on Apr. 18, 2003.

(51) Int. Cl. G06K 7/10

(52) U.S. Cl. 235/468

(57) ABSTRACT

A photo-luminescent marking system is provided. The system comprises a device capable of receiving ink and a barcode print on the device. The barcode print is constructed from photo-luminescent ink readable in diminished lighting situations with the barcode print scannable and decodable by a bar code scanner. A barcode system is also provided. The barcode system comprises a device, a photo luminescent material applied to the device, and barcode print applied to the device over the photo luminescent material. In addition, a method for reading a barcode in diminished lighting conditions is provided.

The present application is a continuation of pending provisional patent application Serial No. 60/464,080, filed on Apr. 18, 2004, entitled “Language In-Sensitive Marking System Using Photo Luminescent Printing of Bar Coded Emergency Information”.

### BACKGROUND OF THE INVENTION

### FIELD OF THE INVENTION

This invention relates generally to a bar code system and, more particularly, the invention relates to a language in-sensitive marking system using photo luminescent printing of bar coded emergency information.

### SUMMARY

The present invention is a photo-luminescent marking system. The system comprises a device capable of receiving ink and a barcode print on the device. The barcode print is constructed from photo-luminescent ink readable in diminished lighting situations with the barcode print scannable and decodable by a bar code scanner.

In addition, the present invention includes a barcode system. The barcode system comprises a device, a photo luminescent material applied to the device, and barcode print applied to the device over the photo luminescent material.

The present invention further includes a method for reading a barcode in diminished lighting conditions. The method comprises printing a barcode with photo-luminescent ink readable in diminished lighting situations and scanning and decoding the barcode print.

### BRIEF DESCRIPTION OF THE DRAWINGS

FIG. 1 is a front view illustrating a language in-sensitive marking system using photo luminescent printing of bar coded emergency information, constructed in accordance with the present invention.

### DETAILED DESCRIPTION OF THE PREFERRED EMBODIMENTS

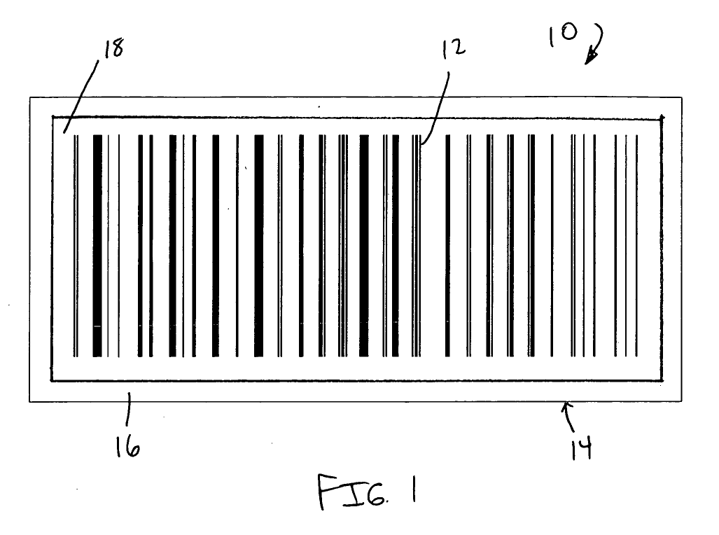

As illustrated in FIG. 1, the present invention is a language in-sensitive marking system using photo luminescent printing of bar coded emergency information, indicated generally at 10. Basically, the system 10 of the present invention is an emergency marking system using the standard bar code 12 for communicating information of hazard, status, or process prompting removing language bias or language awareness for reading in darkness or low light conditions.

The system 10 of the present invention uses standard ink jet printing with photo-luminescent inks on a device 14 securable to a surface (not shown). The present invention is a system 10 for marking hazard and status using a barcode 12 readable in diminished lighting conditions. Process prompting can be communicated without ethnic or language sensitivity for industrial and workplace applications for use by police, fire, military NATO, and UN forces and homeland defense personnel.

To construct the system 10 of the present invention, photo-luminescent powders are dissolved in solution so as to be printed as barcodes 12 that convey information in darkness or low light areas. In an alternative embodiment, the barcode 12 can be constructed from black or other dark ink on a photo-luminescent background 18. Information stored on the bar codes 12 is language bias independent and can be translated with software after being read by standard bar code scanners (not shown). The device 14 can also be bordered with reflective material 16 so if the room is flashed with light, the barcode 12 will be identifiable. The system 10 is intended for use is for emergency, military, NATO, and correctional facilities and homeland defense personnel, although use of the system 10 for other purposes is within the scope of the present invention.

In sum, the photo-luminescent marking system 10 of the present invention is independent of language and removes language bias in critical areas. An integrated barcode system 10 allows printing of photo-luminescent ink to be printed and read. Barcodes 12 are typically scanned from either close or distant proximity and decoded by portable existent bar code scanners.

The system 10 of the present invention can be used to mark hazardous materials, processes, critical steps, status or progress prompting for industrial application for low or no light situations. Flashing a room with intense light illuminates the marking system 10 and order of most critical to less critical of marked items as well as signage.

In the alternative embodiment, the afterglow background 18 with black print barcode 12 can be read at a distance without language bias. The marking system 10 allows marking of materials to be identified and be independent of language for emergency responders. Both afterglow and reflective printing can be used for this application.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A photo-luminescent marking system, the system comprising:
a device capable of receiving ink; and
a barcode print on the device, the barcode print constructed from photo-luminescent ink readable in diminished lighting situations, the barcode print scannable and decodable by a bar code scanner.

2. The marking system of claim 1 wherein the barcode indicates a status selected from the group consisting of hazardous materials, processes, critical steps, status, and progress prompting.

3. The marking system of claim 1 and further comprising:
a reflective border surrounding the barcode print.

4. The marking system of claim 3 wherein the reflective border is constructed from a reflective tape material.

5. The marking system of claim 1 and further comprising:
means for attaching the device to a surface.

6. A barcode system, the barcode system comprising:
a device;
a photo luminescent material applied to the device; and
barcode print applied to the device over the photo luminescent material.

7. The barcode system of claim 6 and further comprising:
means for attaching the device to a surface.

8. The barcode system of claim 6 wherein the barcode print is black.

9. The barcode system of claim 6 and further comprising:
a reflective border surrounding the barcode print.

10. The barcode system of claim 9 wherein the reflective border is constructed from a reflective tape material.

11. The barcode system of claim 6 wherein the barcode indicates a status selected from the group consisting of hazardous materials, processes, critical steps, status, and progress prompting.

12. A method for reading a barcode in diminished lighting conditions, the method comprising:
printing a barcode with photo-luminescent ink readable in diminished lighting situations; and
scanning and decoding the barcode print.

13. The method of claim 12, and further comprising:
indicating a status selected from the group consisting of hazardous materials, processes, critical steps, status, and progress prompting.

14. The method of claim 12, and further comprising:
surrounding the barcode print with a reflective border.

15. The method of claim 14, and further comprising:
constructing the reflective border from a reflective tape material.

16. The method of claim 12 and further comprising:
printing the barcode on a device attachable to a surface.
